(19) United States
(12) Patent Application Publication
(10) Pub. No.: US 2024/0298614 A1
(43) Pub. Date: Sep. 12, 2024

(54) SHELLFISH MICROHATCHERY AND SEEDING PROCESS

(71) Applicant: Joshua Terrell Neese, Pensacola, FL (US)

(72) Inventor: Joshua Terrell Neese, Pensacola, FL (US)

(21) Appl. No.: 18/181,256

(22) Filed: Mar. 9, 2023

(51) Int. Cl. A01K 61/50; A01K 61/90

(52) U.S. Cl. CPC A01K 61/50; A01K 61/90

(57) ABSTRACT

A shellfish microhatchery system includes a laboratory workstation; a reservoir tank with an outlet; a larval tank; and a nursery tank. the larval tank and the nursery tank receive water from the reservoir tank outlet. The nursery tank receives larvae from the larval tank. A method of producing shellfish seed for a farm comprises obtaining sperm and eggs from local broodstock; spawning the sperm and eggs to produce fertilized eggs, aerating the fertilized eggs in a larval tank until the larvae metamorphose into veliger larvae; filtering the veliger larvae; determining a stocking density of the veliger larvae; separating larvae having a shell height of at least about 224 microns; introducing the pediveliger larvae to a cultch-containing vessel; separating larvae having a shell height of at least 300 microns; introducing the separated pediveliger larvae to a grow-out vessel; and growing the separated pediveliger larvae to a predetermined size.

### BACKGROUND OF THE INVENTION

The present invention relates to aquaculture and, more particularly, to a shellfish microhatchery and seeding process.

The oyster aquaculture industry suffers from seed demand outstripping supply. Farms are unable to efficiently grow crops for market, thus driving price increases.

Industrial size hatcheries cannot keep up with the demand of a growing industry, which is growing exponentially due to lack of wild harvests. The industrial hatcheries are costly to establish and to operate, causing cutbacks in labor and seasonal operation. Furthermore, hatcheries typically sell harvests wholesale, so they supply seed to competitors, controlling which seed orders are filled.

The current supply chain is a bottleneck at the seed production, where business-to-business (B2B) sales prevent the farms from successfully producing harvests due to not being able to consistently having access to seed to plant.

As can be seen, there is a need for a method enabling farms to meet their own seed demand. Seed must be produced for self-reliance.

### SUMMARY OF THE INVENTION

In one aspect of the present invention, a shellfish microhatchery system, comprises a laboratory workstation; at least one reservoir tank having an outlet; at least one larval tank; and at least one nursery tank; wherein the at least one larval tank and the at least one nursery tank are operative to receive water from the at least one reservoir tank outlet and the at least one nursery tank is configured to receive larvae from the at least one larval tank.

In another aspect of the present invention, a method of producing shellfish seed for a farm comprises obtaining sperm and eggs from local broodstock; spawning the sperm and eggs to produce fertilized eggs, aerating the fertilized eggs in a larval tank until the larvae metamorphose into veliger larvae; filtering the veliger larvae; determining a stocking density of the veliger larvae; separating pediveliger larvae having a shell height of at least about 224 microns from the veliger larvae by grading with a sieve; introducing the pediveliger larvae to a cultch-containing vessel; separating the pediveliger larvae having a shell height of at least 300 microns by grading with a sieve; introducing the separated pediveliger larvae to a grow-out vessel; and growing the separated pediveliger larvae to a predetermined size.

The present subject matter provides a self-sufficient, steady supply of seed for farms with lower overhead than purchasing the seed from independent hatcheries. This cuts out the middleman, giving the business the freedom to produce seed as needed without restrictions due to limited supply, releasing the industry-wide bottleneck and allowing businesses and the industry as a whole to grow. This method streamlines and packages the current industry supply chain, allowing businesses to operate independently. It offers a more profitable business strategy by completely controlling the production process. The inventive system is scalable and may be as stripped down or expanded as the business desires, while focusing on cost efficiency.

Furthermore, it produces seed that is authentic from a specific estuary, providing a true brand that is of consistent quality for superior marketability. This component of true authentic genetics will push aquaculture into the future as a sustainable alternative to wild harvests, relieving pressures of wild harvests on an already diminished natural population.

These and other features, aspects and advantages of the present invention will become better understood with reference to the following drawings, description, and claims.

### BRIEF DESCRIPTION OF THE DRAWINGS

FIG. 1 is a prior art schematic of the oyster lifecycle;

FIG. 2 is a schematic view of a microhatchery system according to an embodiment of the present invention;

FIG. 3 is a flowchart of a seed oyster production process according to an embodiment of the present invention; and

FIG. 4 is a continuation of the flowchart of FIG. 3.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “seed” refers to shellfish spat.

The term “basin” refers herein to a part of an upweller holding recirculated water, i.e., a sump or the bottom of a tank where the water is circulated through silos and covers a submerged pump.

The term “silos” is used herein to describe detachable “containers” that house larvae during setting; subsequently the post-set spat rest on the silo screen.

Broadly, one embodiment of the present invention is a shellfish seeding system comprising a micro-hatchery and nursery and a seeding process for use therewith. The inventive micro-hatchery may be operated by one person with minimal labor and may be sized and scaled to meet a predetermined production quota. The system may be modular for easy transport and relocation.

While the present disclosure describes oyster aquaculture production, the facility may be utilized for other shellfish production such as clams, scallops, or possibly non-traditional organisms.

A farmer may spawn wild oysters, care for the larvae, and set the larvae to substrate through intensive aquaculture practices. The seed may be moved to the farm, at which time the crop may be cared for according to industry standard practices. The full-production capability maximizes profit, decreases operating costs, and provides self-sufficiency.

A key component is the microhatchery, which is a smaller, scalable version of the industrial hatcheries, established only for the specific business' site and not mass seed production. Wild oysters are spawned, the larvae are reared to setting (where the oyster transitions from free swimming to substrate-affixed), and they are grown until large enough to be stocked on the farm. To maintain low operating costs, the microhatchery may be unused except when periodically needed to produce seed to plant on the farm.

The inventive system comprises a small lab space; larval, nursery, and reservoir tanks; a high-quality saltwater source; pumps and plumbing; and proper drainage in compliance with state and local regulations. The site may be constructed to scale for the farm needs—a fraction of the footprint and costs of a high production facility. The growout farm is generally designed in compliance with state governance. Each of these components enables self-sufficiency and maximum profitability. Each component relies on its subsequent step in the process for the whole to work and benefit the business.

In some embodiments, the method may include further in-house processing according to state regulations for higher profit margins and future growth. In-house processing eliminates the need to sell harvests to processors for resale to distributors. The processing component generally meets Hazard Analysis Critical Control Point (HACCP) standards for food safety.

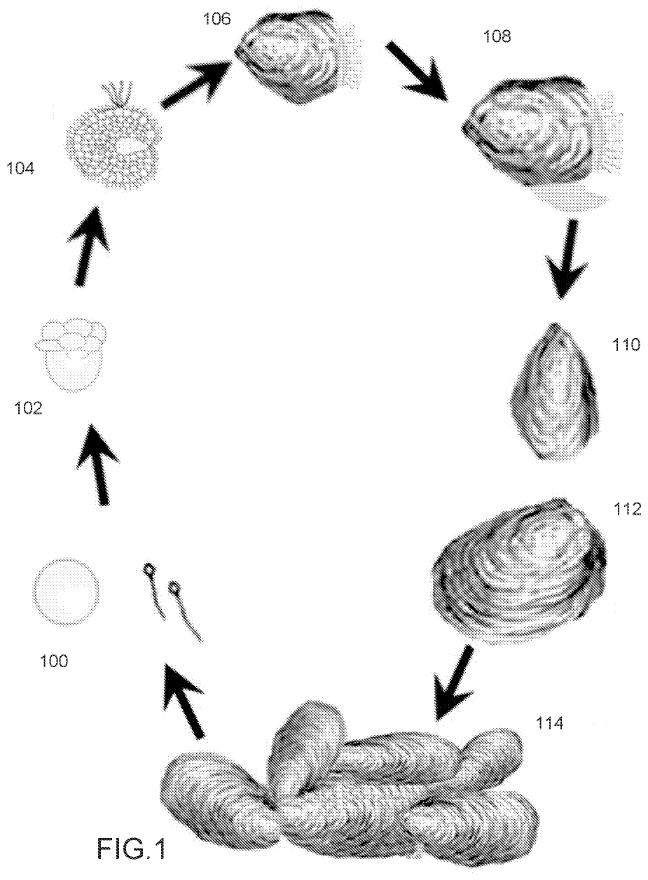

Referring to FIGS. 1 through 4, FIG. 1 illustrates the life cycle of an oyster. The life cycle begins by producing a fertilized egg 102 from an unfertilized egg and sperm 100 (i.e., spawning). The fertilized egg 102 grows through several larval stages, including a trochophore 104, a veliger 106, and a pediveliger 108, at which point setting begins. The oysters go through an early spat stage 110 and a later spat stage 112. Market-size oysters 114 of about 3″ generally take about 10-12 months to grow.

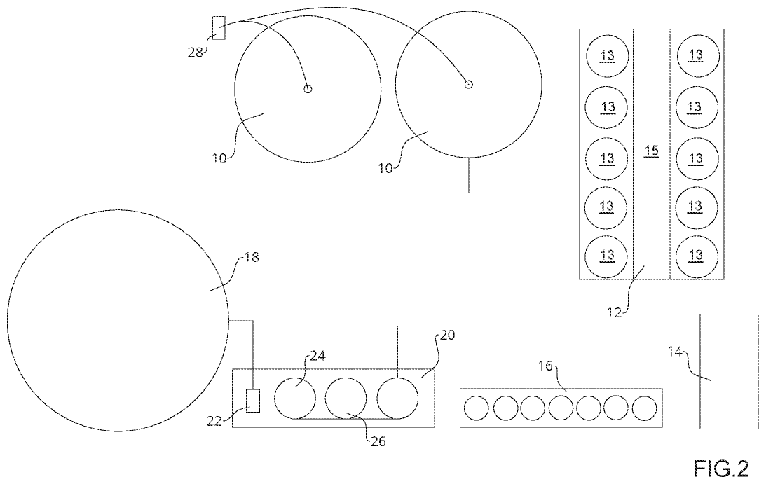

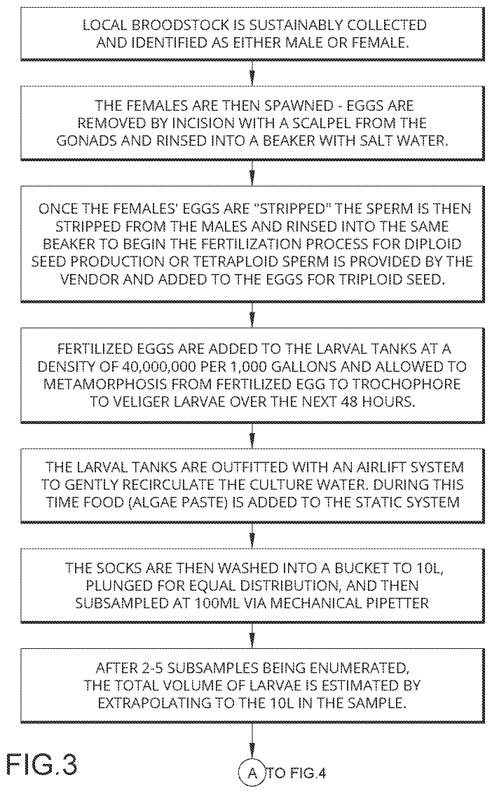

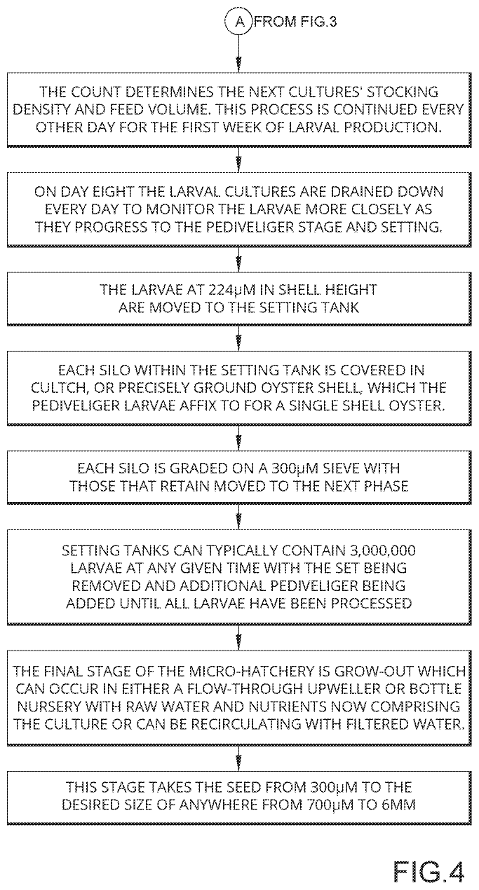

FIG. 2 illustrates a microhatchery system according to an embodiment of the present invention, while FIGS. 3 and 4 present a flowchart of a growing method according to an embodiment of the present invention.

Water used throughout the microhatchery may be mechanically filtered from a reservoir 18. As shown in FIG. 2, a filtration system 20 comprises a pump 22, a cartridge filter 24, and bag filters 26. Water pumped from the reservoir 18 passes sequentially through the cartridge filter 24 and the bag filters 26 before distribution to the various tanks 10, 12, 16.

Local broodstock may be sustainably collected. The females are spawned (eggs are removed by incision), the eggs are rinsed into a beaker with salt water, and sperm is stripped from the males and rinsed into the beaker. Spawning and fertilization are performed at a lab bench 14.

Fertilized eggs may be added to aerated larval tanks 10 at a density of about 40,000,000 per 1,000 gallons for metamorphosis through the trochophore phase to veliger larvae over about 48 hours. The larval tanks 10 may have an aerator or airlift system 28 to gently recirculate the culture water. Food may be added, such as algae paste. Table 1, below, illustrates the increased food demand as the larvae grow.

TABLE 1
Feed and stocking density rates

| | Stocking Density | Stocking Density | Algal Feed |
|---|---|---|---|
| Day | (larvae/mL) | (Total Larvae)/Tank | (mL/Day/Million Larvae) |
| 0 | 10 | 40,000,000 | 0.5 |
| 1 | 10 | 40,000,000 | 1.0 |
| 2 | 5 | 20,000,000 | 2.5 |
| 3 | 5 | 20,000,000 | 3.0 |
| 4 | 5 | 20,000,000 | 4.4 |
| 5 | 5 | 20,000,000 | 5.0 |
| 6 | 4 | 16,000,000 | 5.6 |
| 7 | 4 | 16,000,000 | 6.3 |
| 8 | 4 | 16,000,000 | 9.2 |
| 9 | 4 | 16,000,000 | 10.0 |
| 10 | 3 | 12,000,000 | 11.7 |
| 11 | 3 | 12,000,000 | 13.3 |
| 12 | 3 | 12,000,000 | 15.0 |
| 13 | 3 | 12,000,000 | 16.7 |
| 14 | 3 | 12,000,000 | 20.0 |

The larval tanks 10, a static system, may then be drained through an attached drainpipe and flow control manifold into 20 μm filter socks to gently collect the larvae. The socks may be emptied and rinsed into a bucket containing 10 L of water for enumeration, plunged for equal distribution, and then subsampled at 100 μl with a mechanical pipette. A microscope and Sedgwick-Rafter counter slide may be used to count the number of larvae in the subsample. After 2-5 subsamples have been enumerated, the total volume of larvae is estimated by extrapolating to the 10 L in the sample. The count determines the next cultures' stocking density and feed volume. This process may be continued every other day for the first week of larval production. The larvae are restocked in the larval tanks following enumeration.

From day eight, the larval cultures may be drained down every day to monitor the larvae more closely. The larvae at 224 μm in shell height (determined by grading via a 224 μm sieve) may be moved to a setting tank 12 (about day 11-14), which may also be used as an upweller 12. Smaller larvae may be restocked in the larval tank 10 to continue growing. Between each drain down, the larval tanks are cleaned and refilled in preparation to restock the larvae after counts and measurements.

Water within the setting tank 12 may be recirculated with a submerged pump (not shown) from basins 13 to a trough 15 for a downwelling current. Each silo 13 within the setting tank 12 is covered in cultch, or precisely ground oyster shell, to which the pediveliger 108 larvae affix (over about 72 hours) for a single shell oyster. Preferably, the tank 12 is not drained for about 48 hours to encourage setting. Each silo 13 is graded on a 300 μm sieve, with the larvae retained on the sieve being moved to the next phase. Remaining larvae are returned to the setting tank 12. Setting tanks 12 may contain about 3,000,000 larvae at any given time with the set being removed and additional pediveliger being added until all larvae have been processed.

The final stage of the micro-hatchery is grow-out which may occur in either a flow-through upweller 12, having the same configuration as the setting tanks 12, or a bottle nursery 16 with nutrients and raw water or filtered recirculated water. The seed grow from about 300 μm to a predetermined size, e.g., between about 700 μm and 6 mm. The entire process may take from about 6 weeks to about 3-4 months depending on temperature, broodstock quality, and water chemistry. The oysters may then be stocked on a farm (not shown).

It should be understood, of course, that the foregoing relates to exemplary embodiments of the invention and that modifications may be made without departing from the spirit and scope of the invention as set forth in the following claims.

What is claimed is:

1. A shellfish microhatchery system, comprising:
a laboratory workstation;
at least one reservoir tank having an outlet;
at least one larval tank; and
at least one nursery tank;
wherein the at least one larval tank and the at least one nursery tank are operative to receive water from the at least one reservoir tank outlet and the at least one nursery tank is configured to receive larvae from the at least one larval tank.

2. The shellfish microhatchery system of claim 1, wherein the at least one larval tank comprises a setting tank having cultch-covered silos and a trough operative to maintain a downwelling current.

3. The shellfish microhatchery system of claim 1, further comprising a filtration system having a pump, a cartridge filter, and at least one bag filter fluidly communicating with the at least one reservoir tank; and wherein the filtration system is configured to receive water drained from the at least one larval tank and the at least one nursery tank prior to entry into the at least one reservoir tank.

4. The shellfish microhatchery system of claim 1, wherein the laboratory workstation; the least one reservoir tank having an outlet; the at least one larval tank; and the at least one nursery tank are dimensioned to produce seed for an individual farm.

5. The shellfish microhatchery system of claim 1, wherein the at least one reservoir tank further comprises a filtration system having a pump, a cartridge filter, and at least one bag filter; wherein the at least one reservoir tank outlet fluidly communicates with the cartridge filter via the pump and the cartridge filter fluidly communicates with the at least one bag filter.

6. The shellfish microhatchery system of claim 5, wherein the reservoir is configured to receive water drained from the at least one larval tank and the at least one nursery tank.

7. The shellfish microhatchery system of claim 1, wherein the shellfish microhatchery system is modular.

8. A method of producing shellfish seed for a farm, comprising:
obtaining sperm and eggs from local broodstock;
spawning the sperm and eggs to produce fertilized eggs,
aerating the fertilized eggs in a larval tank until the larvae metamorphose into veliger larvae;
filtering the veliger larvae;
determining a stocking density of the veliger larvae;
separating pediveliger larvae having a shell height of at least about 224 microns from the veliger larvae by grading with a sieve;
introducing the pediveliger larvae to a cultch-containing vessel;
separating the pediveliger larvae having a shell height of at least 300 microns by grading with a sieve;
introducing the separated pediveliger larvae to a grow-out vessel; and
growing the separated pediveliger larvae to a predetermined size.
